(19) United States
(12) Patent Application Publication
(10) Pub. No.: US 2011/0103728 A1
(43) Pub. Date: May 5, 2011

(54) SEAL FOR BEARINGS TO ACCOMMODATE LARGE DEFORMATIONS

(75) Inventors: John Cowles, Somers, CT (US); Charles Houle, Thomaston, CT (US); Roman Malychok, Jamison, PA (US); Robert Pallini, Chetleham, PA (US); Serge Bochnovich, Langhorne, PA (US)

(73) Assignee: ROLLER BEARING COMPANY OF AMERICA, INC., OXFORD, CT (US)

(21) Appl. No.: 12/905,240

(22) Filed: Oct. 15, 2010

Related U.S. Application Data
(60) Provisional application No. 61/251,766, filed on Oct. 15, 2009.

(51) Int. Cl. F16C 33/76; F16J 15/32; F16J 15/44; F16C 19/36

(52) U.S. Cl. 384/484; 277/351

(57) ABSTRACT

A seal for a bearing has a first and a second circumference, and an anchor portion proximate to the first circumference. A span portion extends from the anchor portion towards the second circumference, and a lip extends from the span portion towards the second circumference. The lip protrudes from the span portion transversely to the span direction. A bearing and seal assembly includes a first ring and a second ring in rotatable engagement with the first ring. The first ring defines a groove and the second ring defines a contact surface. The seal is mounted in the groove, the span portion extending from the anchor portion towards the second ring, and the lip extending from the span portion towards the second ring, engaging the contact surface. The bearing and seal assembly may be used as a pitch bearing and/or a yaw bearing in a wind turbine.

### CROSS REFERENCE TO RELATED APPLICATION

This application claims the benefit of U.S. provisional application No. 61/251,766, filed Oct. 15, 2009, the contents of which are incorporated herein by reference in their entirety.

### FIELD OF THE INVENTION

This invention relates to a seal for a bearing having inner and outer rings and which undergoes large movements between the inner and outer rings.

### BACKGROUND

Four- and eight-point contact ball bearings are used when moving parts are expected to be subject to a variety of loads such as radial, thrust, and moment loads. In wind turbines, large four or eight point contact ball bearings are used for yaw bearings and pitch bearings. The yaw bearings allow the nacelle, rotor, and blades to rotate in order to face into the wind. The pitch bearings serve two purposes: connection of each blade to the rotor and also to allow the blade to change its pitch depending on wind speed and conditions. The pitch bearings experience large relative deformations between their inner and outer rings due to large and random loads due to rotor rotation and variable winds. The bearings have inner and outer rings with a seal between the rings to help retain grease therein.

Pitch bearings and seals are seen in U.S. Pat. No. 7,331,761 and U.S. Patent Application Publication Nos. 20040026867; 20080104821; 20080246224.

### SUMMARY OF THE INVENTION

The present invention resides in one aspect in a seal having a first circumference and a second circumference. The seal has an anchor portion proximate to the first circumference, a span portion extending in a span direction from the anchor portion towards the second circumference, the span portion including a hinge region. There is also a lip extending from the span portion to the second circumference. The lip is configured to protrude from the span portion in a direction that is transverse to the span direction.

According to another aspect of the invention, a bearing and seal assembly is provided which includes a first ring and a second ring in rotatable engagement with the first ring. The first ring defines a groove and the second ring defines a contact surface. The assembly includes a seal having an anchor portion mounted in the groove, a span portion extending from the anchor portion towards the second ring, and a lip extending from the span portion to the second ring and making engagement with the contact surface. The second ring comprises a groove in which the lip is disposed.

According to another aspect of the invention, a wind turbine having a pitch bearing and a yaw bearing includes a bearing and seal assembly as described herein.

### BRIEF DESCRIPTION OF THE DRAWINGS

FIG. 1 is a schematic, partial cross-sectional view of a one example of seal described herein.

FIG. 2A is a schematic, partial cross-sectional view of a one example of a bearing for use with seal as described herein.

FIG. 2B is a partial enlargement of the view of FIG. 2A.

FIG. 3A is a schematic, partial cross-sectional view of the seal of FIG. 1 combined with the bearing of FIG. 2.

FIG. 3B is a partial enlargement of the view of FIG. 3A.

FIG. 4 is a schematic view of a wind turbine showing pitch bearings and a yaw bearing as described herein.

### DETAILED DESCRIPTION

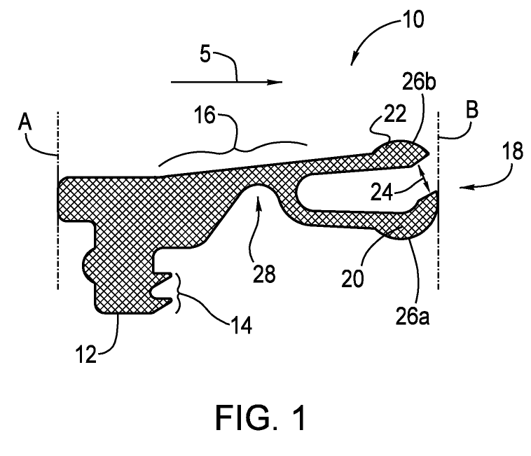

A seal indicated at 10 in FIG. 1 is configured for use in a bearing which undergoes large radial and axial relative movements between the inner and outer rings of the bearing. The seal 10 is generally annular about a central axis and has a first circumference at ‘A’ and a second circumference at ‘B’. In one embodiment, first circumference at ‘A’ and a second circumference at ‘B’ are substantially concentric and coplanar with each other, but the invention is not limited in this regard, and in other embodiments the two circumferences may be displaced from one another in an axial direction (i.e., vertically relative to the orientation of the seal shown in FIG. 1). At or near (i.e., proximate to) the first circumference A, the seal 10 is configured to have an anchor portion 12 which is configured to engage a corresponding seating groove in a first bearing ring. The anchor portion 12 includes a barbed portion 14 for engaging the first bearing ring.

The seal 10 has a span portion 16 which extends in a direction indicted by arrow S from the anchor portion 12 toward the second circumference B, where the seal 10 is configured to have a lip 18. In one embodiment, the lip 18, which is generally annular in shape, has a split configuration and includes a first lip member 20 and a second lip member 22 which are both joined to the span portion 16, and which are separated by a gap 24. The seal 10 is made of an elastomeric material so that when first lip member 20 and second lip member 22 are compressed towards each other (causing the gap 24 to diminish), the seal generates a responsive force tending to separate the first lip member 20 from the second lip member 22. Suitable elastomeric materials include, but are not limited to, VITON® fluoroelastomer (VITON® is a registered trademark of E. I. Du Pont De Nemours & Company, 1007 Market St., Wilmington Del.), acrylon nitrile, nitrile rubber, or rubber compounds blended for resistance to UV rays and moist salt air. The lip 18 is configured for sliding engagement with a second ring bearing. In particular, the lip 18 is configured to protrude from the span portion 16 obliquely from the span portion 16 to provide first and second seal surfaces 26a, 26b on the first lip member 20 and on the second lip member 22, respectively, for sliding contact with a bearing ring. Thus, in one embodiment, the lip 18 has a generally toroidal configuration.

The span portion 16 includes a hinge region 28 around which the lip 18 can rotate relative to the anchor portion 12 as described hereinbelow. In one embodiment, the hinge region 28 is a region of reduced thickness relative to the rest of the span portion 16 and/or relative to the anchor portion 12.

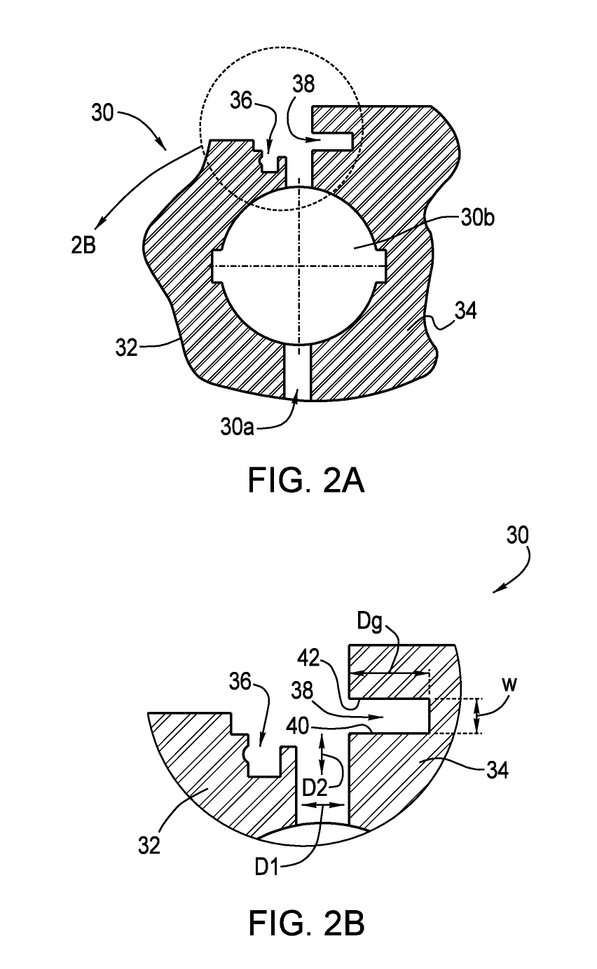

A bearing shown in partial cross-section at 30 in FIG. 2A and FIG. 2B is configured to receive the seal 10. The bearing 30 includes a first ring 32 and a second ring 34 with an interior space 30a between them where rolling elements 30b are disposed. The first ring 32 has a first groove 36 configured to receive the anchor portion 12 of the seal 10. As illustrated, the bearing 30 is configured to accommodate rolling elements 30b that are balls, and bearing 30 is a ball bearing. In particular embodiments, the bearing 30 may be a four- or eight-point contact ball bearing. However, the invention is not limited in this regard, and in other embodiments the bearing 30 may be configured to accommodate cylinders or any other suitable rolling elements.

The second ring 34 has a second groove 38 which is annular in configuration and which provides first and second groove surfaces 40 and 42. The second groove 38 has a depth in the second ring 34 indicated at Dg, and a width indicated at W. The bearing 30 is shown with the first ring 32 and a second ring 34 in their nominal positions relative to each other. The first ring 32 and the second ring 34 are expected to experience movement from the nominal relative positions in directions indicated in FIG. 2B by arrows D1 and D2 (“direction D1” and “direction D2”).

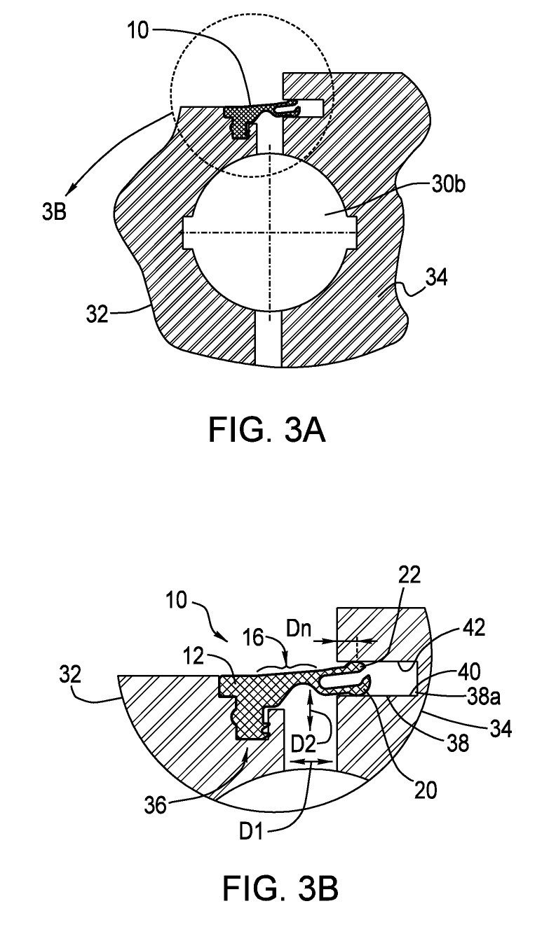

The seal 10 is combined into the bearing 30 as shown in FIG. 3A and FIG. 3B in an orientation such that the exterior of the bearing is above the seal 10. The anchor portion 12 fits into the first groove 36 of the first ring 32 with the barbed portion 14 engaging the first ring. The span portion 16 extends from the anchor portion 12 toward the second ring 34, and the lip 18 protrudes into the second groove 38. In one embodiment, the first ring 32 and the second ring 34 are concentrically disposed, one within the other, and the span portion 16 extends radially from the anchor portion 12 towards the second ring.

For purposes of inserting the lip 18 into the seal groove 42, the first lip member 20 and second lip member 22 are compressed towards each other. Optionally, the seal surfaces 26a, 26b may be configured so that the lip 18 can be positioned against the mouth of the second groove 38 and, with the application of insertion force, the first lip member 20 and second lip member 22 are compressed together as the lip 18 enters the second groove and engages in sliding, sealing contact with the two groove surfaces 40 and 42. For example, the circumferential surface of the lip 18 may be generally rounded, tapered, chamfered or the like. The width W of the second groove 38 is dimensioned such that an interference is maintained between the first lip member 20 and second lip member 22 and the groove surfaces 40 and 42, respectively, while the lip 18 is in the second groove 38. As a result of this configuration, when the first lip member 20 and the second lip member 22 are in sealing contact with the groove surfaces 40 and 42 respectively, an annular sealed compartment 38a is formed in the second groove 38.

As relative motion between the first ring 32 and the second ring 34 occurs, the position of the lip 18 in the second groove 38 can change accordingly without causing a gap between the seal 10 and the second ring 34, because one or both of the first lip member 20 and second lip member 22 remains in sealing contact with the groove surfaces 40 and/or 42 by sliding upon them.

The bearing 30 has two groove surfaces 40 and 42 and the seal 10 has two seal surfaces 26a, 26b, but the invention is not limited in this regard, and in other embodiments a seal need only have one contact surface for sliding contact with a bearing contact surface, or a seal may have more than two seal surfaces for sliding contact with one or more groove surfaces on a bearing ring.

When the seal 10 is oriented horizontally, as seen in FIG. 3A and FIG. 3B, the span portion 16 is sloped so that the span portion sheds water and other contaminants away from the second groove 38. This feature of the seal 10 helps keep contaminants outside the bearing 30 because the contact between the anchor portion 12 and the first groove 36 is better at preventing the passage of water and other contaminants therethrough into the interior space 30a than the contact between the lip 18 and the groove surfaces 40 and 42. However, the engagement between the anchor portion 12 and the first groove 36 is not designed to accommodate motion between the seal 10 and the first ring 32.

In one embodiment, the seal 10 and the bearing 30 are sized and configured such that in their respective nominal positions, the contact points of the first lip member 20 and second lip member 22 against the groove surfaces 40 and 42 are central relative to the depth of the second groove 38. In this way, sealing contact can be maintained between the lip 18 and the second ring 34 through a wide range of relative motion between the first ring 32 and a second ring 34 towards each other or away from each other caused by distortion of the bearing 30. The depth Dg of the second groove 38 can be made deep enough to allow for the largest anticipated relative motion between bearing rings 32, 34 in a direction parallel to the depth Dg, i.e., in direction D1.

The hinge region 28 of the seal 10 allows flexibility and control of the seal movement when relative ring movement occurs in direction D2. If the rings move relative to each other in direction D2, the first lip member 20 and second lip member 22 will tend to rotate about a circumferential axis through the hinge region 28. The toroidal shape of the lip 18, i.e., of the two lip members 20 and 22 together, allows for positive contact of the lip members with the groove surfaces 40 and 42 throughout such movement.

During the operation of the bearing 30, the seal 10 is able to move back and forth (in direction D1) in the second groove 38 in response to distortion in the bearing. Lubricant (e.g., grease) in the interior space 30a which makes its way past seal surface 26a and groove surface 40 will be contained in the second groove 38 by the sealing contact between the seal surface 26b and the second groove surface 42.

In one embodiment, the first lip member 20 (seen as the lower lip in the orientation of FIG. 1 and FIG. 3A and FIG. 3B) has a protruding configuration, i.e., the fist lip member is configured to protrude into the second groove 38 farther than the second lip member 22. This is achieved by disposing the gap 24 (FIG. 1) between the first lip member 20 and the second lip member 22 at an offset from the radial direction indicated by arrow S. As a result, the first lip member 20 has more surface area disposed toward a groove surface in the annular sealed compartment 38a than the second lip member 22. Then, when the seal 10 moves deeper into the second groove 38, the pressure in the annular sealed compartment 38a will rise and generate greater net lifting force on the first lip member 20 than on the second lip member 22. The seal 10 is configured so that the force required to lift first lip member 20 off from the first groove surface 40 is about the same as the force required to lift the second lip member 22 off from the second groove surface 42, so the net lifting force causes the first lip member to rise off the first groove surface 40 before the second lip member 22 lifts away from the second groove surface 42. This will allow pressurized fluid in the annular sealed compartment 38a to pass into the interior space 30a, so that lubricant (e.g., grease) in the annular space 38a is returned to the interior space. In this way, the operation of the bearing 30 with the seal 10 therein produces a pumping action which pumps lubricant from the second groove 38 back into the interior space 30a of the bearing 30 rather than purging out of the bearing to exterior surfaces of the bearing.

The seal 10 and bearing 30 described herein are useful in various applications to prevent gaps between the seal and the bearing when the bearing experiences large radial and axial relative movements between the first ring 32 and the second ring 34, by maintaining sealing contact between the lip 18 and the second ring 34 despite substantial relative movement between them. Such motion may occur, for example, in bearings in wind turbines, which experience radial and axial relative movements as large as 0.5 inches (12.7 mm). If gaps occur between bearing ring and seal during operation, lubricant could escape the bearing and water, dust, and other contaminates can get in.

An escape of lubricant from the interior of a bearing, especially from pitch bearings, and the entrapment of contaminants within the lubricant from outside the bearing, are both detrimental to the operation of the bearing in a wind turbine or other device. Another feature of wind turbine pitch bearings is that the orientation of the bearings changes as the rotor of the wind turbine rotates. Gravity cannot be used to determine the dominant motion of lubricant or oil within the bearing. The seal 10 and bearing 30 described herein address these problems by maintaining the function of the seal in the bearing despite large radial and axial relative movements between the first ring 32 and the second ring 34 of the bearing. Not only is the function of the seal 10 maintained during such movements but the shape of the seal is such that a pumping action of the lubricant back into the bearing occurs.

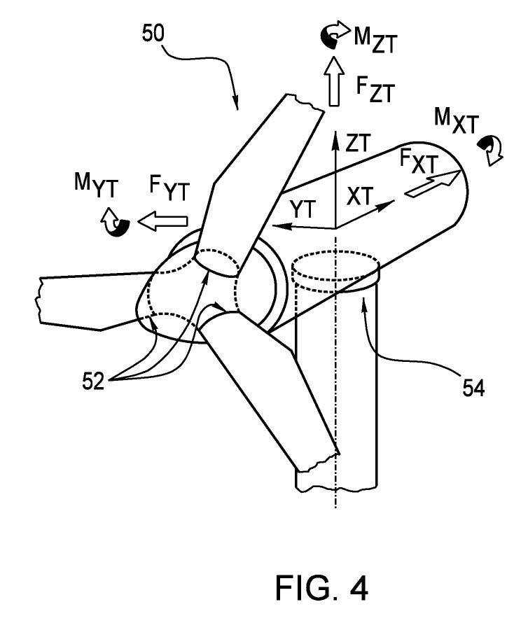

A wind turbine, indicated generally at 50 in FIG. 4, includes pitch bearings 52 and a yaw bearing 54, at least one of which includes a bearing and seal assembly as described herein.

The terms “first,” “second,” and the like, herein do not denote any order, quantity, or importance, but rather are used to distinguish one element from another. The terms “a” and “an” herein do not denote a limitation of quantity, but rather denote the presence of at least one of the referenced item.

Although the invention has been described with reference to particular embodiments thereof, it will be understood by one of ordinary skill in the art, upon a reading and understanding of the foregoing disclosure, that numerous variations and alterations to the disclosed embodiments will fall within the scope of this invention and of the appended claims.

What is claimed is:

1. A seal comprising:
a first circumference and a second circumference;
an anchor portion proximate to the first circumference;
a span portion extending in a span direction from the anchor portion towards the second circumference, the span portion including a hinge region; and
a lip extending from the span portion towards the second circumference;
wherein the lip is configured to protrude from the span portion in a direction that is transverse to the span direction.

2. The seal of claim 1, wherein the anchor portion includes a barbed portion.

3. The seal of claim 1, wherein the lip has at least two lip members including a protruding lip member.

4. The seal of claim 1, wherein the lip has at least two lip members which have a toroidal configuration.

5. A bearing and seal assembly comprising:
a first ring and a second ring in rotatable engagement with the first ring, the first ring defining a groove and the second ring defining a contact surface; and
a seal having an anchor portion mounted in the groove, a span portion extending from the anchor portion towards the second ring, and a lip extending from the span portion towards the second ring and making engagement with the contact surface;
wherein the second ring comprises a groove in which the lip is disposed.

6. The bearing and seal assembly of claim 5, wherein the anchor portion includes a barbed portion.

7. The assembly of claim 5, wherein the span portion has, in cross-section, a thin region which can serve as a hinge region to accommodate relative motion between the first ring and the second ring.

8. The assembly of claim 5, wherein the first ring and the second ring are disposed one within the other and the span portion extends radially from the first ring toward the second ring, and wherein the contact surface is oriented radially such that the lip can remain in contact with the contact surface during relative displacement of the first ring and the second ring.

9. The assembly of claim 5, wherein the lip has at least two lip members which have a toroidal configuration.

10. The assembly of claim 8, wherein the bearing is a ball bearing.

11. The assembly of claim 10, wherein the bearing is a 4- or 8-point contact ball bearing.

12. The assembly of claim 5, wherein the lip has at least two lip members including a protruding lip member.

13. A wind turbine comprising a pitch bearing and a yaw bearing, wherein at least one of the pitch bearing and the yaw bearing comprises a bearing and seal assembly according to claim 5.

14. The wind turbine of claim 13, wherein the anchor portion includes a barbed portion.
